(19) United States
(12) Patent Application Publication
(10) Pub. No.: US 2010/0308209 A1
(43) Pub. Date: Dec. 9, 2010

(54) System for Charge-Domain Electron Subtraction in Demodulation Pixels and Method Therefor

(75) Inventors: Berhard Buettgen, Adliswill (CH); Michael Lehmann, Winterthur (CH); Jonas Felber, Niederbipp (CH)

Correspondence Address: HOUSTON ELISEEVA, 420 BEDFORD ST, SUITE 155, LEXINGTON, MA, 02420, US

(73) Assignee: MESA IMAGING AG, Zurich (CH)

(21) Appl. No.: 12/797,515

(22) Filed: Jun. 9, 2010

Related U.S. Application Data
(60) Provisional application No. 61/185,389, filed on Jun. 9, 2009.

(51) Int. Cl. H01L 27/146; H01L 31/09

(52) U.S. Cl. 250/208.1; 257/215; 250/214 R; 250/214 SW; 257/E31.052

(57) ABSTRACT

A method and system enable the subtraction of charge carrier packages in the low-noise charge domain, which is particularly interesting for the operation of demodulation pixels when high background light signals are present. The method comprises the following steps: demodulation of an optical signal and integration of the photo-generated charge carriers; charge transfer to an external capacitance. The second step means a recombination of electrons and holes in the charge domain and an influencing of the opposite charge carriers on the second plate of the capacitance. This approach allows for low-noise subtraction of charge packages in the charge domain and, at the same time, for creating pixels with much higher fill factors because the capacitances can be optimized for storing just the differential parts, without the DC component.

### RELATED APPLICATIONS

This application claims the benefit under 35 USC 119(e) of U.S. Provisional Application No. 61/185,389, filed on Jun. 9, 2009, which is incorporated herein by reference in its entirety.

### BACKGROUND OF THE INVENTION

All demodulation pixels existing today perform a sampling or a correlation process in the electro-optical domain. In general, photons are converted into electron-hole pairs. Depending on the wafer type, either electrons or holes are exploited in the further in-pixel post-processing steps, while the other type of charge carrier is dumped by the bulk layer. Commercially available devices generally use electrons as the charge carriers.

The demodulation pixels transfer the photo-generated electrons to dedicated storage or post-processing circuitry areas. The time required for the transfer determines the possible sampling frequency of the pixel.

The demodulation pixels can be roughly classified into two groups:

1. Demodulation pixels that do the necessary processing of the photo-signal in the current domain. Examples these devices are disclosed in: U.S. Pat. No. 6,777,659 B1 by Schwarte; D. van Nieuwenhove et al., “Novel Standard CMOS Detector using Majority Current for guiding Photo-Generated Electrons towards Detecting Junctions”, Proceedings Symposium IEEE/LEOS Benelux Chapter, 2005; and US 2002/0084430 A1 to Bamji.

2. Demodulation pixels that perform the whole sampling process in the charge domain. Examples have been described in: 5,856,667 to Spirig; U.S. Pat. No. 7,498,621 B1 to Seitz; and “Demodulation Pixel Based on Static Drift Fields”, IEEE Transactions on Electron Devices, 53(11):2741-2747, November 2006 by B. Büttgen, F. Lustenberger and P. Seitz.

The current-domain based demodulation pixels have one major disadvantage. The fact that photo-currents are evaluated means that additional noise sources are introduced to the sampling/demodulation process at pixel level. The number of noise sources in charge-based signal processing is reduced to the minimum. It has been shown that the ultimate physical limitation given by photon shot noise is reached already for low light levels. See T. Oggier, M. Lehmann, R. Kaufmann, M. Schweizer, M. Richter, P. Metzler, G. Lang, “An all-solid-state optical range camera for 3D real-time imaging with sub-centimeter depth resolution (SwissRanger)”, Proc. Of the SPIE, Vol. 5249, pp. 534-545, 2004.

Charge-based signal processing, thus, shows great performance in terms of low noise contributions. However, there is no method available that allows for subtracting two charge packets in the charge domain, which means that the demodulation pixels need to store the unnecessary DC signal components. This limits the remaining storage capacity for the signal component and, hence, reduces the dynamic range of the sensor significantly.

The only existing approach for the suppression of the DC signal component in the charge domain is based on the readout of the signal part of the charge carriers only and keeping the common mode part still in the storage capacitances. See T. Oggier, R. Kaufmann, M. Lehmann, B. Büttgen, S. Neukom, M. Richter, M. Schweizer, P. Metzler, F. Lustenberger, and N. Blanc, “Novel pixel architecture with inherent background suppression for 3D time-of-flight imaging”, Proc. Of the SPIE, Vol. 5665, pp. 1-8, January 2005.

### SUMMARY OF THE INVENTION

The problem with past approaches to DC suppression is that there is no real cancellation in the charge domain, since the common mode charge carriers remain in the pixel. Thus, the dynamic range due to background light in the scene is still limited by the total storage capacitance in the pixel.

The present invention solves the problem of limited dynamic range of charge-based demodulation pixels. The proposed solution performs the subtraction of the charge packets in the charge domain without increasing noise.

In general, according to one aspect, the invention features a method for sampling in a demodulation pixel, comprising: demodulating of an optical signal and integrating photogenerated charge carriers and transferring the photogenerated charge carriers to a common capacitance.

In embodiments, the photogenerated charge carriers are transferred to either of the two storage areas preferably by a drift field generator. In examples, the drift field generator comprise gate structures and/or built-in drift fields and/or diffusions and/or pinned photodiodes. An electrode contact voltage pattern generator controls the switches to move photogenerated charge carriers from the two storage areas to the common capacitance. The storage areas are preferably implemented as gate structures in the pixel.

In general, according to another aspect, the invention features a demodulation pixel comprising a demodulation region that demodulates of an optical signal and integrates photogenerated charge carriers in at least two storage areas, a common capacitance, and transfer switches that transfer the photogenerated charge carriers to the common capacitance.

In general, according to another aspect, the invention features a demodulation sensor, comprising an array of pixels, each of the pixels including a demodulation region that demodulates of an optical signal from a scene and integrates photogenerated charge carriers in at least two storage areas, a common capacitance and transfer switches that transfer the photogenerated charge carriers to the common capacitance. A modulated light source illuminates the scene by generating the optical signal.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a circuit diagram showing the basic circuitry for a demodulation pixel that provides common mode rejection in the charge domain using a capacitor according to the present invention;

FIGS. 2A-2F are timing diagrams showing the charge packet storage in partial transfer mode of operation;

FIGS. 3A-3F are timing diagrams showing the charge packet storage in skimming mode of operation;

FIGS. 4A and 4B are schematic cross-sectional views showing a transistor switch operating in skimming mode, FIG. 4A shows the switch successively implemented with a storage gate, FIG. 4B shows the switch controlling the charge flow from a diffusion capacitance;

FIGS. 5A-5D are plots of voltage as a function of phase showing the potentials at the sense nodes and on at the external capacitor C3 when only background light present;

FIGS. 6A-6B are plots of voltage as a function of phase showing the differential voltage across the external capacitance C3 when only background light is present, FIG. 6A shows the voltage at the different sequence steps, and FIG. 6B shows the voltages at the different sequence steps over the number of charge shifts;

FIGS. 7A-7D are plots of voltage as a function of phase showing the potentials at the sense nodes and on at the external capacitor C3 when only signal light is present;

FIGS. 8A-8B are plots of voltage as a function of phase showing the differential voltage across the external capacitance C3 when only signal light is present, FIG. 8A shows the voltages at the different sequence steps, and FIG. 8B shows the voltages at the different sequence steps over the number of charge shifts;

FIGS. 9A-9D are plots of voltage as a function of phase showing the potentials at the sense nodes and at the external capacitor C3 when background light and signal light is present;

FIGS. 10A-10B are plots of voltage as a function of phase showing the differential voltage across the external capacitance C3 when background light and signal light are present, FIG. 8A shows the voltage at the different sequence steps, and FIG. 8B shows the voltages at the different sequence steps over the number of charge shifts;

FIGS. 11A and 11B are circuit diagrams showing the basic circuitry for a demodulation pixel using absolute readout, FIG. 11A shows the sense node readout, and FIG. 11B shows C3's nodes readout;

FIGS. 12A and 12B are circuit diagrams showing the basic circuitry for a demodulation pixel using differential readout, FIG. 12A shows the sense node readout, and FIG. 12B shows C3's nodes readout;

FIGS. 13A-13C are schematic cross-sectional views of demodulation pixels enabling the integration of background light cancellation based on the subtraction of two charge packets in the charge domain;

FIG. 14 is a chip layout diagram showing the implementation of the pixel architecture in a sensor;

FIG. 15 is a schematic drawing showing the principle of 3D imaging;

FIG. 16 is a plot of intensity as a function of time showing the emitted and detected signal in a 3D imaging system; and

FIG. 17 illustrates the relationships between the background-to-signal ratio, the signal difference on sample level and the theoretical standard deviation in cm when assuming an ideally performing demodulation pixel that is just limited by photon shot noise and being operated at 20 MHz demodulation frequency.

### DETAILED DESCRIPTION OF THE PREFERRED EMBODIMENTS

Mostly, p-doped wafers are used in commercial time of flight (TOF) three dimensional (3D) imaging devices or in fluorescence lifetime imaging (FLIM) so that the flow of electrons is exploited for further processing and storage of the information. Therefore, in all following description, electrons are considered as the charge carriers that are exploited as the information carriers. However, this does not limit the generality of the present invention since holes could be used as the information carrier. In this case all doping and voltage considerations would be reversed.

The preferred embodiment is applied to demodulation architectures in which outputs are two charge packets stored on two capacitors. This also includes the current-domain demodulation devices mentioned above, because a subsequent integration of the currents on capacitors would be possible, which corresponds to the transition into the charge domain again. Typical types of capacitors in charge-domain-based demodulation pixels are built by poly-silicon gates or implantation diffusion nodes.

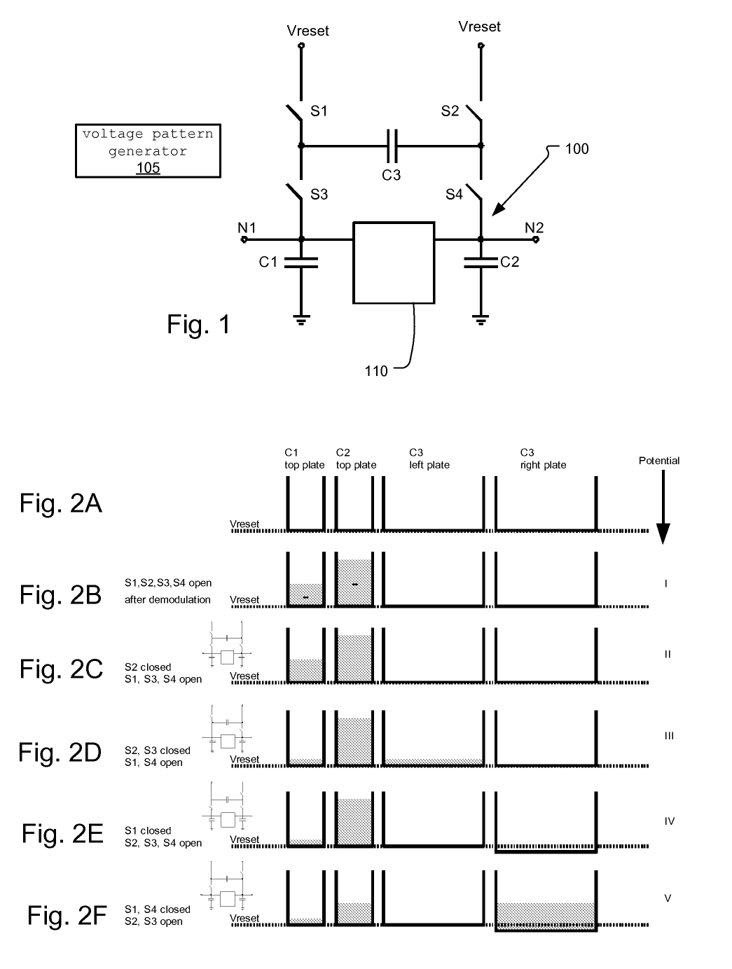

FIG. 1 shows capacitors C1 and C2 that depict the default storage nodes that accumulate the photogenerated charges from the photosensitive region and/or demodulation region 110 of the demodulation pixel 100. The demodulation region might be completely, partially or not at all photo-sensitive, depending on the application.

The photo-sensitive and/or demodulation region 110 might be built by gate structures, photo diodes, built-in drift fields, current assisted demodulation structures, pinned diode or combinations of these. However, embodiments presented herein are not be restricted to only these demodulation architectures.

In order to subtract the two charge packets demodulated by photo-sensitive and/or demodulation region 110 and stored on the capacitors C1, C2, a third common capacitor C3 is provided. This third capacitor is separated from the demodulation pixel and the sampling storage capacitors C1, C2 by four switches denoted as S1, S2, S3 and S4 that are controlled by a voltage pattern generator 105.

The nodes denoted by N1 and N2 are referred to as sense nodes that are typically read out. However, also the readout of the nodes of the capacitor C3 is possible, which is described later in more detail.

Generally, one can distinguish between two modes of operation: 1. high sensitivity mode of operation; and 2. background cancellation mode of operation. These two modes of operation are discussed below.

It is noted at this point that this invention is not restricted to pixel architectures that have only 2 outputs of the demodulation device. Any enhanced demodulation device with an arbitrary number of output storage stages can be implemented. For each difference that has to be calculated between two storage nodes' charge packets, another external capacitance needs to be added.

The number of storage nodes has to be compromised in the final application with the space available per pixel, the required frame rate and the required measurement accuracy. This is the task of the designer but there is no limitation in terms of number of output stages given that could be implemented using the principles of the present invention.

High-Sensitivity Mode of Operation

In the high sensitivity mode of operation just the capacitances that are inherent to the demodulation device are used to store the charge packets. The switches S3 and S4 are never used during integration or read out. Thus, the effective capacitances for read out are C1 and C2 instead of the sums C1+C3 and C2+C3, respectively.

In the following, the background suppression mode of operation is described. This mode of operation incorporates the step of subtracting the charge packets in the charge domain.

Background Suppression Mode of Operation

The demodulated charge packets are sequentially transferred from the storage nodes C1 and C2 to the capacitance C3. In this mode of operation the exact timing of the switches S1, S2, S3 and S4 is important and can lead to different operational properties.

Furthermore, the switches S1, S2, S3 and S4 are operated in two different ways depending on the applied gate voltages. The first approach is to use them as switches that open or close the lines to the capacitance C3. This is done by applying high control voltages. We call this mode of operation partial charge transfer mode (pctm) since the charge is not fully transferred to the external capacitance, but the potential is equalized between them. The second approach is to use intermediate voltage levels for the switches, which are implemented as a single n-channel transistor. This enables the full charge-domain subtraction of the charge packets on C3. This mode of operation is called skimming mode or full charge transfer mode (fctm). Those two implementations are described later.

Partial Charge Transfer Mode

FIGS. 2A-2F show the sequence of controlling the four switches S1, S2, S3 and S4 illustrated in FIG. 1 to implement a partial charge transfer mode of operation.

It starts with resetting all nodes of the capacitors C1, C2 and C3 to the same potential Vreset shown in FIG. 2A.

The demodulation of the photogenerated charges in the photosensitive region 110 in phase I generates two charge packets that are stored on the top plates of C1 and C2 as shown in FIG. 2B. This demodulation phase I might take on to several thousands and even millions of demodulation cycles and accumulate the photo-generated charges on C1 and C2.

In phase II the switch S2 is closed, which puts the right node of C3 to the reset potential again, as shown in FIG. 2C.

Since the starting sequence is shown, there are no charges stored on C3 yet so that there is no change from FIG. 2B to FIG. 2C. In FIG. 2D in phase III, the charge from C1's top plate is shared between C1 and C3 by closing S2 and keeping S3 closed. During this process the same number of holes is influenced on the other capacitor's plate.

After that, S2 and S3 are opened again and the left plate of C3 is set to reset potential again in FIG. 2E by closing switch S1 in phase IV. Since S3 is open, the voltage on the right plate is increased by the voltage generated by the shared charge carriers.

Phase V shown in FIG. 2F has switch switches S1 and S4 closed and switches S2 and S3 open, which means the sharing of the charge carriers on C2 with C3.

The phases from 1 to V are preferably repeated several times for one single demodulation process in order to increase the signal to noise ratio. Finally, the differential voltage across C3 corresponds to the cumulative difference between the charge packets stored in C1 and C2.

Skimming Mode or Full Charge Transfer Mode

Skimming is a well-known technique that is applied in photo-diode based pixels in order to increase their sensitivity. In the present embodiment, this technique is exploited for enabling the transport of the full charge packets to another capacitance without any significant loss of charge carriers.

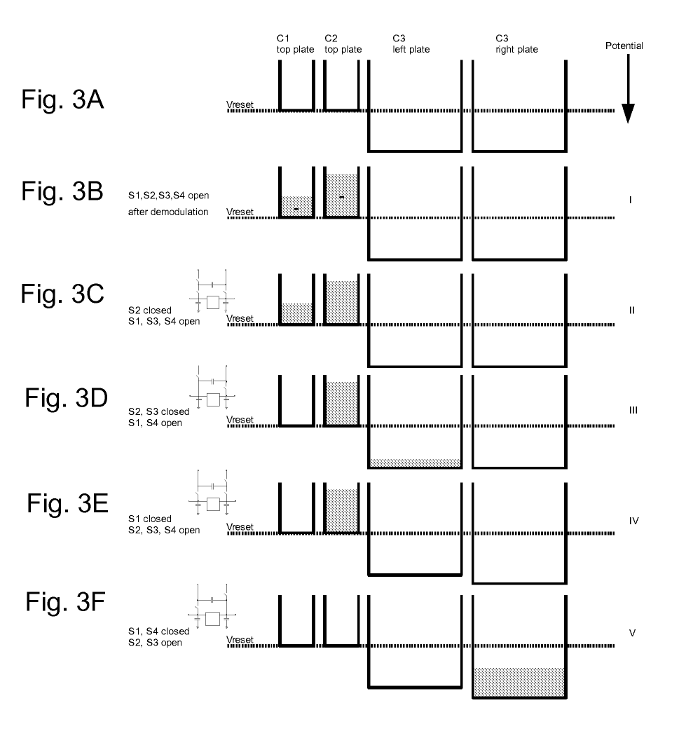

FIGS. 3A-3G illustrate the skimming mode of operation in the present embodiment of FIG. 1.

The nodes of C1 and C2 are reset to a lower potential than the two nodes of C3 as shown in FIG. 3A. The switches S3 and S4 are usually realized by common transistor elements. Their gates are controlled by an intermediate voltage between the low reset potential of C1 and C2 and the high reset potential on C3. This enables the effect that all charge carriers are skimmed from C1 or C2 to one of the two plates of C3.

This skimming mode of operation realizes a perfect transfer of the charge packets from the capacitances C1 and C2 to the plates of C3. Basically the control sequence is the same as for the partial charge transfer mode. The main difference is the different control voltage used for the switches and the different reset voltages. The differential voltage across C3 corresponds to the difference of the charge packets.

As shown in FIG. 3B, the demodulation of the photogenerated charges in photosensitive region 110 in phase I generates two charge packets that are stored on the top plates of C1 and C2.

In phase II the switch S2 is closed, which puts the right node of C3 to the reset potential again, as shown in FIG. 3C.

In FIG. 3D, phase III, the charge from C1's top plate is shared between C1 and C3 by closing S2 and keeping S3 closed. During this process the same number of holes is influenced on the other capacitor's plate.

After that, S2 and S3 are opened again and the left plate of C3 is set to reset potential again in FIG. 3E by closing switch S1 in phase IV. The voltage on the right plate is increased by the voltage generated by the shared charge carriers. Step V shown in FIG. 3F has switch switches 51 and S4 closed and switches S2 and S3 open, which means the sharing of the charge carriers on C2 with C3.

The steps from Ito V are preferably repeated several times for one single demodulation process in order to increase the signal to noise ratio. Finally, the differential voltage across C3 corresponds to the difference of both charge packets stored in C1 and C2.

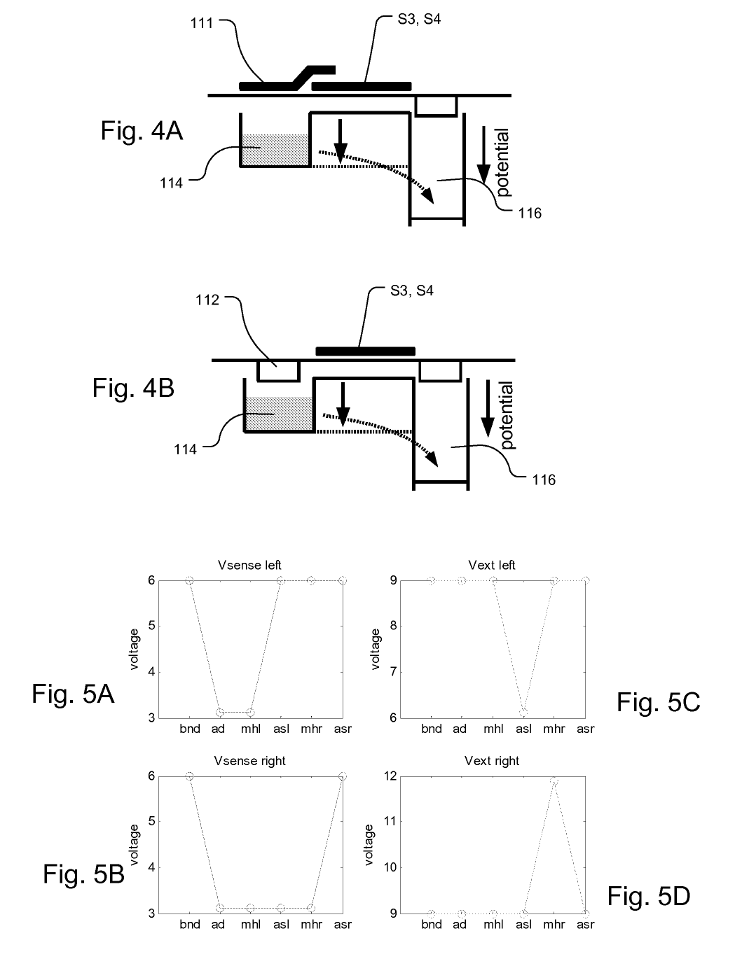

FIGS. 4A and 4B show two typical implementations of the switches S3 and S4. They illustrate how the switches operate in skimming mode. FIG. 4A shows the case where the switch is located successively to another storage gate region 111. FIG. 4B follows to a diffusion capacitance 112. By increasing the potential of the transistor gate S3, S4 to the one indicated in the figure, the charge carriers will flow from the left storage region 114 to the right storage region 116.

The potential level under the gate S3,S4 (the dashed horizontal line) is lower than the right potential. Charge can only flow from left to right. If the switches are not used in the skimming mode, the gate potentials are higher and the channel potential is therefore below the right potential. Here, the charge can flow in either direction, therefore both potentials will equalize.

The ideal behavior is obtained when no charge is trapped somewhere, no noise sources are present and no parasitic capacitances are assumed. The following sections show the basic characteristics of the voltages for an ideal system operating in skimming mode of operation and three different cases: 1. Only constant background light is present. 2. Only signal light is present. 3. The impinging optical signal is a combination of constant background light and modulated signal light.

The sizes of the charge packets have been chosen in such a way that the function of the principle becomes apparent. However, the number of charge shifts to the external capacitance C3 and the voltage swings will differ in reality.

All graphs use the following notations and correspondences:

C3: external capacitance with potentials Vextright and Vextleft on the left and right plates, respectively, referenced the FIG. 1.

Left and right capacitance's top plates are nodes that are referred to as sense nodes. The left sense node has the potential Vsenseleft and the right sense node has the potential Vsenseright.

bnd: before next demodulation (at the starting point, this is the reset phase).

ad: after demodulation.

mhl: make holes left (this is when one plate of the external capacitor is connected to the reset voltage but the other plate is still floating).

asl: after shift left.

mhr: make holes right.

asr: after shift right.

FIGS. 5A-5D shows potentials at the sense nodes and on at the external capacitor C3 when only background light present.

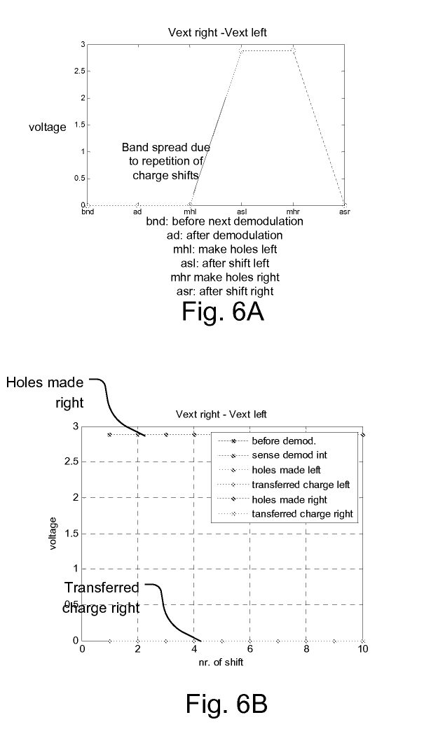

FIG. 6A shows the differential voltage across the external capacitance C3 when only background light is present. FIG. 6B shows the voltage at the different sequence steps. FIG. 6B shows voltages at the different sequence steps over the number of charge shifts. The result is a perfect cancellation of the two equal charge packets on C1 and C2, and the differential output of N1 and N2 stays zero.

In FIGS. 5A-5D and FIGS. 6A and 6B, although several cycles through the phases Ito V are plotted, one can see only a few plots since all charges cancel due to non-modulated background light which is equally demodulated on C1 and C2.

If only signal light is present, that means that there is only a charge packet on one of the sense nodes. The difference between the sense nodes' charge packets is targeted to be read out.

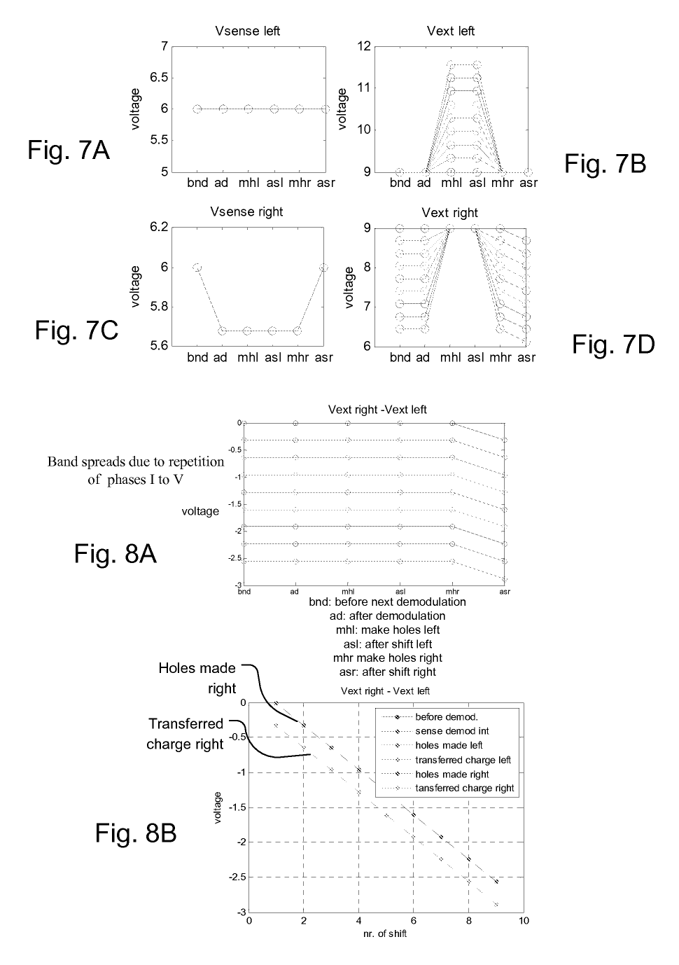

FIGS. 7A-7D show the potentials on the left and right sense nodes and on the two sides of the external capacitor C3 over an example of 9 iterations of shift cycles.

FIGS. 8A shows the differential voltage across the external capacitance C3 when only signal light is present. FIG. 8B shows the voltages at the different sequence steps over the number of up to nine cycles through phases Ito V.

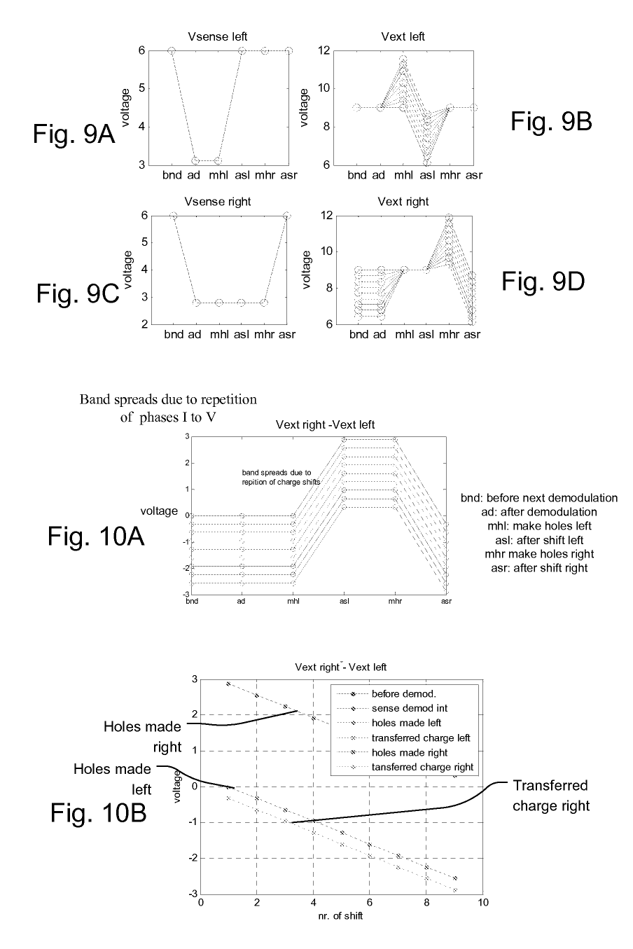

FIGS. 9A-9C show the potentials on the sense nodes and at the external capacitance under the assumption that the sum of a signal light component and a constant background light component is detected. In this simulation, a factor of 9 between signal and background light has been used, which, however, could be completely arbitrary in reality.

FIGS. 10A and 10B show the differential voltage across the external capacitance C3 when background light and signal light is present. FIG. 10A shows the voltage at the different sequence steps. FIG. 10B shows the voltages at the different sequence steps over the number of up to nine cycles through phases Ito V.

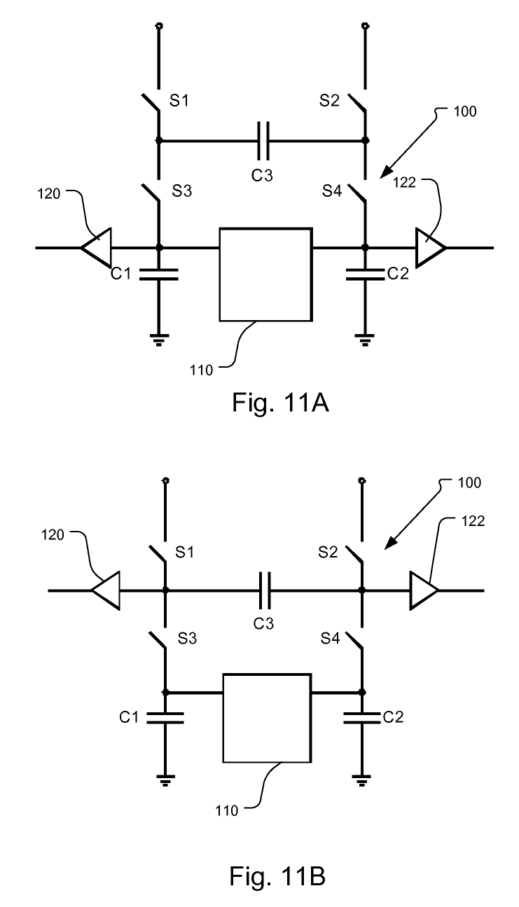

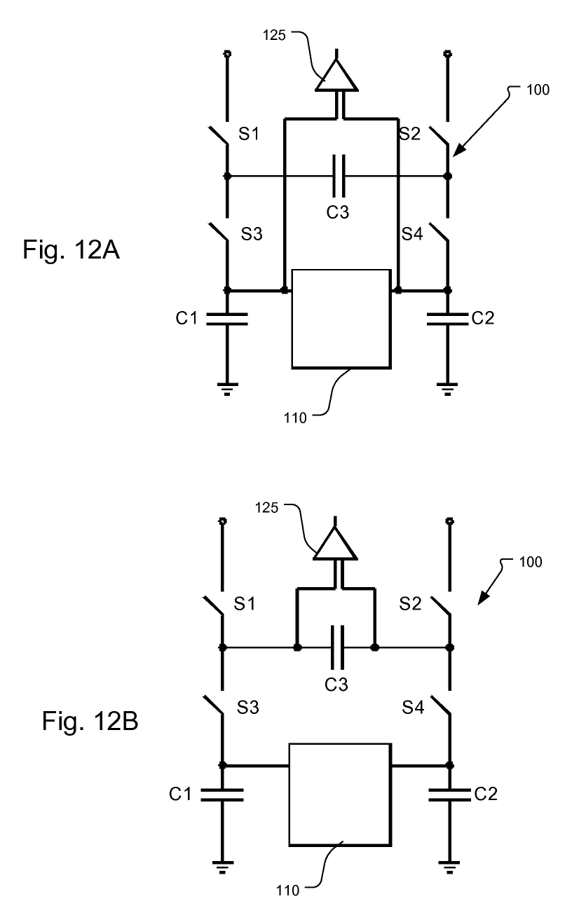

The pixel can be read out either by absolute amplification, as shown in FIGS. 11A and 11B, or by differential amplification as shown in FIGS. 12A and 12B using differential amplifier 125. Basically, the amplification stages shown in these pictures could be integrated in the pixel or column-wise on sensor-level.

FIGS. 11A and 11B illustrate the absolute value read out. Two amplification stages 120, 122 are depicted, one for each readout node. However, depending on the particular operation of the pixel, it could also be enough to read out just one side when applying a known voltage to the other side. This reduces the number of read out values to a minimum of 1 output. On the other hand, it restricts the readout to the architecture where the nodes of the capacitor C3 deliver the output values. This means that for a single ended output, only the readout architecture of FIG. 11B could be applied and the pixel could not be operated in the high sensitivity mode where the external capacitor C3 is not used for the integration process.

The readout of the sense nodes as depicted in FIG. 11A and FIG. 12A enables all possible operations of the pixel, meaning the two background light cancellation modes and the high sensitivity mode of operation. However, if the skimming mode of operation is used, the charge needs to be shared again between C3 and C1 respectively C2, which requires an appropriate controlling of the switches S3 and S4 in terms of timing and voltage appliance.

The above illustrated embodiments provide for enhancement over previous demodulation pixels in terms of background light cancellation. The necessary subtraction of two charge packets is performed in the charge domain, which means lowest noise contribution. In the following the most important gains of the invention compared to prior-art demodulation devices are itemized:
Full cancellation of electrons that are generated by background light under the assumption that the same amount of charge carriers has been generated on the capacitances whose packets are subtracted.
Charge subtraction is performed in the low noise charge-domain. This ensures that there is no loss of measurement accuracy due to the subtraction in the analogue pixel domain.
Prior-art pixels always require two reset transistors and, in addition to that, two other transistors if the background suppression is used. The background light cancellation method of the present invention is also realized with just 4 transistors including any necessary reset transistors.

Embodiments of the present invention are applied to different demodulation pixel architectures that perform an integration of the photo-generated charge carriers on a capacitance. Examples of possible demodulation devices are the gate-based devices as disclosed in:

EP 1 624 490 A1 to Büttgen;

B. Büttgen, T. Oggier, M. Lehmann, R. Kaufmann, F. Lustenberger, “CCD/CMOS Lock-In Pixel for Range Imaging: Challenges, Limitations and State-of-the-Art”, 1st Range Imaging Days, ETH Zurich, 2005;

U.S. Pat. No. 5,856,667 to Spirig;

U.S. Pat. No. 6,777,659 B1 to Schwarte;

T. Ushinaga et al., “A QVGA-size CMOS time-of-flight range image sensor with background light charge draining structure”, Three-dimensional image capture and applications VII, Proceedings of SPIE, Vol. 6056, pp. 34-41, 2006.

The embodiment of the present invention also utilize photo diode- or CMOS-(complementary metal oxide semiconductor) based devices as disclosed in:

US 2002/0084430 A1 to Bamji;

E. Charbon, “Methods for CMOS-compatible three-dimensional image sensing using quantum efficiency modulation”, July 2002, US 2002/0084430 A1;

Stoppa, David, Luigi Viarani, Andrea Simoni, Lorenzo Gonzo, Mattia Malfatti and Gianmaria Pedretti, A 50×30-pixel CMOS Sensor for TOF-based Real Time 3D Imaging, In Proceedings of the 2005 Workshop on Charge-Coupled Devices and Advanced Image Sensors, Karuizawa, Nagano, Japan, 2005.

Another embodiment might apply built in drift fields. Such devices have been disclosed in:

Holger Vogt, “Devices and Technologies for CMOS Imaging”, 5^{th} Fraunhofer IMS Workshop on CMOS Imaging, 2010

Cedric Tubert et al. “High speed dual port pinned photo dioded for time-of-flight imaging”, International Image Sensor Workshop, Bergen, Norway, 2009.

Another possible embodiment of the invention might also be based on a demodulated pinned photo diodes. Such demodulation devices are presented in:

Cedric Tubert et al. “High speed dual port pinned photo dioded for time-of-flight imaging”, International Image Sensor Workshop, Bergen, Norway, 2009.

U.S. Pat. No. 6,794,214 B2 to Berezin;

A last embodiment can be designed onto a current assisted deodulatin device, such as presented in:

EP 1 513 202 A1 to Kuijk;

D. van Nieuwenhove et al., “Novel Standard CMOS Detector using Majority Current for guiding Photo-Generated Electrons towards Detecting Junctions”, Proceedings Symposium IEEE/LEOS Benelux Chapter, 2005;

All these differences in the embodiments relate to the photosensitive region and/or demodulation region 110 of the demodulation pixel 100.

In the preferred embodiments shown in the following sections, the photosensitice region and/or demodulation region 110 based on overlapping gates has been used for description, but this part could easily be replaced by any of the photosensing and demodulation approaches cited before. Further, in-pixel capacitances C1 and C2 are based for example on diffusion capacitances or gate capacitances as shown in FIG. 4B in still other embodiments.

Examples of Integrated Devices with Background Light Cancellation

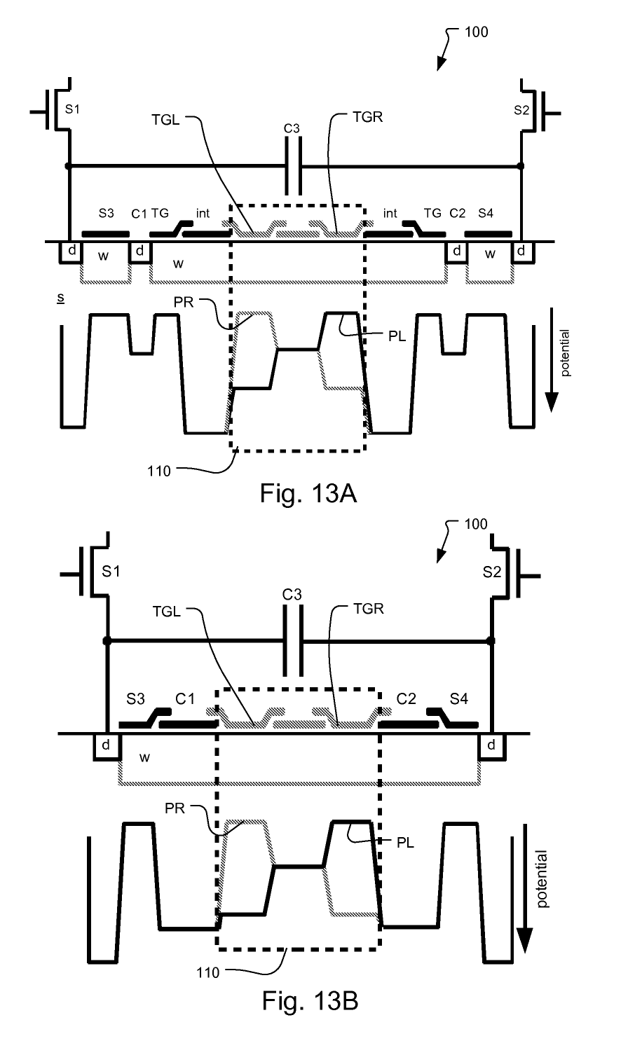

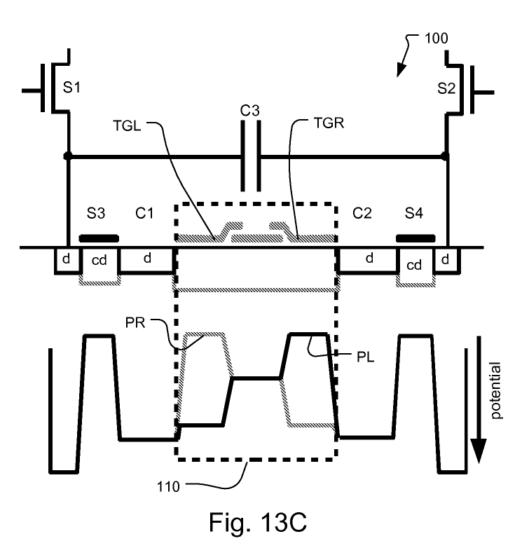

FIGS. 13A-13C show three embodiments of the invention, where the potential distribution for the skimming mode of operation is included in all embodiments. The rectangle in the middle indicates the photo-sensitive area and demodulation region 110, which accomplishes at the same time the demodulation of the optical signal by switching between two potential distributions PL and PR that produce lateral drift fields. The two potential distributions are generated in the substrate S by a drift field generator that is implemented by modulating the voltage applied to the left toggle gate TGL and the right toggle gate TGR. In other embodiments, the drift field generator is implemented as pinned photodiode structures or minority currents though the substrate.

These two potential distributions cause photogenerated charges in photosensitive region 110 to move either to the left integration region int or the right integration region int due to the resulting lateral drift fields.

Charges in the integration region are then moved to the respective capacitances C1, C2 via the intervening transfer gates TG.

Areas d in the substrate region are the diffusion areas of the transistors' source/drain regions. Areas w are weakly doped regions. The implementation of such a buried channel is optional, however, it increases the charge transfer efficiency during the transfer of charge packets from one capacitance to another.

FIG. 13A shows the demodulation pixel 100 with integration capacitances C1, C2 that are implemented as gate storage elements. Transfer gates TG decouple the integration gates int from the capacitance C1, C2, which are a diffusion capacitance.

In FIG. 13B, diffusion area between the gate of S3 and TG and the TG are dropped, so that S3 is directly integrated into the chain of gates adjacent the photosensitive region 110. Capacitances C1 and C2 are implemented by gates.

In FIG. 13C, capacitances C1 and C2 are implemented as diffusions cd.

The approach of FIG. 13B has the advantage that a very compact and highly integrated gate structure is realized, while FIG. 13A shows benefits in terms of decoupling the storage capacitances from high frequencies used for the demodulation.

Since embodiments of the invention are implemented in every photo-sensitive pixel 100, it is possible to scale up the number of pixels on one chip. In a sensor, the pixels 100 are aligned in a row of such pixel devices or to a 2-dimensional array to provide an image sensor having a certain number of rows and columns of these devices.

The number of outputs of one pixel depends on the particular number of outputs of the demodulation stage and on the type of readout architecture chosen (absolute or differential).

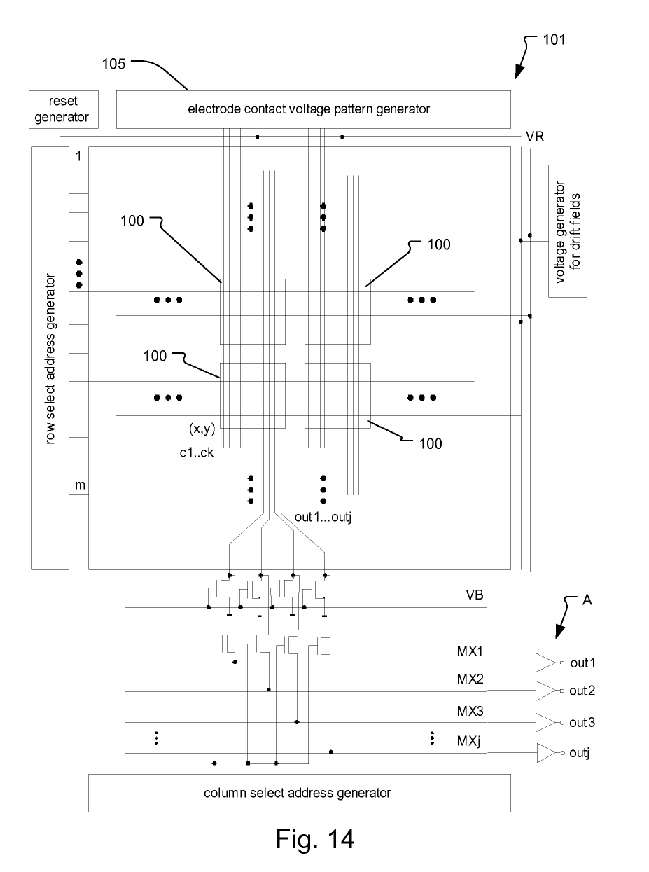

FIG. 14 shows a four output lines for each pixel 100 in sensor 101, but this can easily vary for the reasons outlined above.

Additional electronics including a row select address generator (row decoders) and a column select address generator (column decoders), voltage generators that provide the voltage to toggle gates TG to generate the drift fields, and amplification stages A are added for the full functionality of the sensor.

Embodiments of the invention are preferably applied to the field of 3D imaging. Particularly in outdoor applications high background light signals lead quickly to saturation of prior-art pixel architectures preventing them for delivering reliable distance data. This problem is solved with the disclosed pixel architecture because the common background part is subtracted in the charge domain.

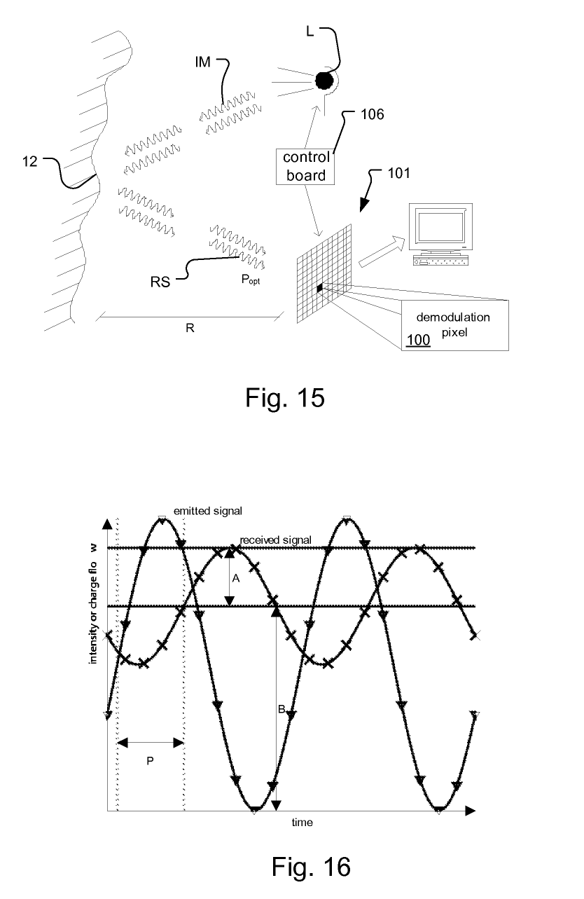

FIG. 15 illustrates the basic principle of a 3D imaging application. A light source L emits an intensity-modulated signal IM, which is reflected by the object 12 in the scene and imaged onto the sensor 101. The sensor 101 is comprised by an array of demodulation pixels 100. The pixels, and specifically the drift field generators in the pixels, are controlled synchronously with the optical modulation signal IM so the output can mathematically be described by a sampling process. The control board 106 ensures that the light source L is synchronized with the sampling of the sensor 101.

The pixels can be any demodulation pixel. However, in the presence of high background light signal it is recommended to use the architecture described herein to get rid of the common mode charge carriers.

FIG. 16 shows the signal characteristics of the emitted signal IM and received signal RS for the example of sinusoidal modulation. In this case, the output of the demodulation pixels is a certain number of samples of the sine wave. At least 3 samples are necessary, so that the sine wave can be fully reconstructed in terms of amplitude, offset and phase. For simplicity reasons, most 3D imaging systems sample the sine wave four times, where the samples are equally distributed by 90 degree. In this case the phase can be calculated as

P=a tan [(A0−A180)/(A90−A270)]

where A0, A90, A180, A270 denote the four samples at the phases of 0, 90, 180 and 270 degrees, respectively. The phase proportionally corresponds to the sought distance information.

Following this formula, it is obvious that the common mode of generated charge packets can be discarded, meaning that any background light generated electrons do not contribute to the extraction of the distance information.

In reality, arbitrary high ratios between the background light power and the signal power can occur. In the case that the background light generated electrons can be cancelled, the storage capacitances in the pixel can fully be optimized for the storage of as large signal differences as possible. A higher number of signal electrons leads to less noisy distance measurements.

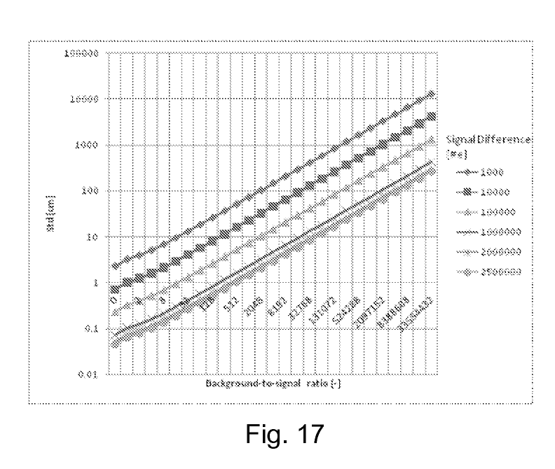

FIG. 17 shows a simulation of the distance measurement's standard deviation due to photon shot noise when an ideally sampling of the demodulation pixel is assumed. The band of curves describe the standard deviation for different maximum signal differences that still can be stored and depending on the background-to-signal light ratio. With previous demodulation pixels one can say that a factor between background light and signal light of up to around 5 can efficiently be suppressed before pixel saturation occurs. With the present invention, this factor can more or less arbitrarily be increased, just depending on the number of shift cycles and smallest integration times per cycle. The external capacitance C3 can be optimized for storing a high number of charge carriers. The full well value of C3 determines the attainable distance resolution.

While this invention has been particularly shown and described with references to preferred embodiments thereof, it will be understood by those skilled in the art that various changes in form and details may be made therein without departing from the scope of the invention encompassed by the appended claims.

What is claimed is:

1. A demodulation pixel comprising:
a demodulation region that demodulates a photo-generated signal and integrates photogenerated charge carriers in at least two storage areas;
a common capacitance; and
transfer switches that transfer the photogenerated charge carriers to the common capacitance.

2. A demodulation pixel as claimed in claim 1, wherein the photogenerated charge carriers are transferred to either of the two storage areas by drift field generator.

3. A demodulation pixel as claimed in claim 2, wherein the drift field generator comprises gates structures.

4. A demodulation pixel as claimed in claim 2, wherein the drift field generator comprises pinned photodiodes.

5. A demodulation pixel as claimed in claim 1, further comprising an electrode contract voltage pattern generator that controls the switches to move photogenerated charge carriers from the two storage areas to the common capacitance.

6. A demodulation pixel as claimed in claim 1, wherein the storage areas are implemented in gate structures in the pixel.

7. A demodulation pixel as claimed in claim 1, wherein the storage areas are implemented in a diffusion in the pixel.

8. A method for sampling in a demodulation pixel, comprising:
demodulating a photo-generated signal and integrating photogenerated charge carriers; and
transferring the photogenerated charge carriers to a common capacitance.

9. A method as claimed in claim 8, wherein the step of demodulating comprises transferring photogenerated charge carriers to either of two storage areas synchronously with modulated light illuminating a scene.

10. A method as claimed in claim 9, further comprising generating a drift field for transferring the photogenerated charge carriers to storage sites prior to transferring the photogenerated charge carriers to the common capacitance.

11. A method as claimed in claim 8, further comprising controlling the switches to move photogenerated charge carriers from the pixel to the common capacitance.

12. A method as claimed in claim 8, wherein the method is repeated several times before the pixel is read out.

13. A demodulation sensor, comprising
an array of pixels, each of the pixels including a demodulation region that demodulates a photo-generated signal from a scene and integrates photogenerated charge carriers in at least two storage areas, a common capacitance and transfer switches that transfer the photogenerated charge carriers to the common capacitance; and
a modulated light source illuminating the scene by generating the optical signal.

14. A sensor as claimed in claim 13, wherein the photogenerated charge carriers are transferred to either of the two storage areas in each of the pixels by a drift field generator.

15. A sensor as claimed in claim 14, wherein the drift field generator comprises gate structures.

16. A sensor as claimed in claim 14, wherein the drift field generator comprises pinned photodiodes.

17. A sensor as claimed in claim 13, further comprising an electrode contract voltage pattern generator that controls the switches to move photogenerated charge carriers from the two storage areas to the common capacitance of each of the pixels.

18. A sensor as claimed in claim 13, wherein the storage areas are implemented in gate structures in the pixel.

19. A sensor as claimed in claim 13, wherein the storage areas are implemented in a diffusion in the pixel.
